(19) United States
(12) Patent Application Publication
(10) Pub. No.: US 2012/0027295 A1
(43) Pub. Date: Feb. 2, 2012

(54) KEY FRAMES EXTRACTION FOR VIDEO CONTENT ANALYSIS

(75) Inventor: Ling Shao, Sheffield (GB)

(73) Assignee: KONINKLIJKE PHILIPS ELECTRONICS N.V., EINDHOVEN (NL)

(21) Appl. No.: 13/263,628

(22) PCT Filed: Apr. 14, 2010
(86) PCT No.: PCT/IB2010/051620

§ 371 Date: Oct. 7, 2011

(30) Foreign Application Priority Data
Apr. 14, 2009 (EP) 09305316.3

(51) Int. Cl. G06K 9/48; G06K 9/00

(52) U.S. Cl. 382/170; 382/197

(57) ABSTRACT

A method of extracting a key frame from a sequence of frames constituting a shot, each frame being constituted by a matrix of pixels, comprises: for each frame of the sequence of frames: computing (3) the optical flow of the frame compared to the following frame as a matrix of displacement of each pixel from the frame to the following frame; computing (5) a motion entropy measure based on the optical flow of the frame; selecting (7) as key frame the frame of the sequence of frames having the maximum motion entropy measure.

### FIELD OF THE INVENTION

The invention relates to the field of extraction of key frames in a sequence of frames constituting a shot for representing the shot in video summarization, browsing, searching and understanding.

### BACKGROUND OF THE INVENTION

With the rapid growth of popularity in storing and viewing digital video in Internet, mobile devices and a wide range of video applications, an effective management of the video data becomes much more important than ever before.

For automatic video retrieval, it is almost impossible to use keywords to describe video sequences. The reasons are that manual annotation requires tremendous manpower, and the keywords used tend to be inaccurate and subjective. Therefore, content-based techniques which can provide efficient indexing, retrieval and browsing to video sequences will be a solution.

A generic approach for managing video data is to segment a video into groups of related frames called “shots” by means of shot cut detection or scene break detection. After indentifying the shot boundaries, one or more key frames or representative frames can be extracted from each group of frames (GoF) or video shot. The visual contents on these key frames are then used to represent the video shots for indexing and retrieval.

Key frame extraction is an essential part in video analysis and management, providing a suitable video summarization for video indexing, browsing and retrieval. The use of key frames reduces the amount of data required in video indexing and provides the framework for dealing with the video content.

Key frame extraction can be done either in scene or shot level. Usually the analysis in shot level is preferred as it preserves the time sequence of the selected key frame in the video frame set.

Current key frame extraction techniques can be categorized into the following six classes:

Shot boundary based approach, visual content based approach, motion analysis based approach, shot activity based approach, unsupervised clustering based approach, and macro block based approach. These methods have their merit respectively.

For instance, document US2005/0002452 discloses a key frame extraction based on an entropy measure which is defined by a luminance distribution and a comparison with adjacent frames so that the frame with the least motion activity is selected.

It appears that known extraction methods do not perform well to select frames containing complex and fast-changing motions which may be used for action recognition.

### SUMMARY OF THE INVENTION

It would advantageous to achieve a method of extracting key frames representative of the movement(s) captured by the shot.

To better address one or more concerns, in a first aspect of the invention a method of extracting a key frame from a sequence of frames constituting a shot, each frame being constituted by a matrix of pixels, comprises:
for each frame of the sequence of frames:
   computing the optical flow of the frame compared to the following frame as a matrix of displacement of each pixel from the frame to the following frame;
   computing a motion entropy measure based on the optical flow of the frame;
selecting as key frame the frame of the sequence of frames having the maximum motion entropy measure.

The method has the particular advantage to select frame(s) with complex and fast-changing motions.

In a particular embodiment,
the displacement of each pixel being defined as a vector having a modulus and an angle of displacement, a motion histogram is defined by a predetermined number of bins representing a combination of modulus and angle of displacement.
the bin having the highest frequency is discarded.
the motion entropy measure is the sum of the motion entropy measure of every bins, the motion entropy measure of one bin being proportional to the frequency of appearance of the bin in the motion histogram.
the bin entropy measure is weighted by the absolute value of the logarithmic frequency of appearance of the bin.
the motion histogram of each frame is compared to the motion histogram of another frame to define the motion entropy measure of the frame as a similarity measure.
a plurality of key frames are extracted by selecting the frames of said sequence of frames having the maximum motion entropy measure in a sliding window with a predetermined length of frames.
the displacement of each pixel being defined as a vector having a modulus and an angle of displacement and a motion histogram being defined by a predetermined number of bins representing a combination of modulus and angle of displacement, the motion entropy measure is the sum of the motion entropy measure of every bins, the motion entropy measure of one bin being proportional to the frequency of appearance of the bin in the motion histogram and,
the method further comprises for each selected frames, comparing to the motion histogram of its neighboring frames and weighting the motion entropy measure of each selected frame by the result of the comparison.

In a second aspect of the invention a computer software product stored on a recording media and comprising a set of instructions to enable a computer to practice the method disclosed hereabove when the computer executes the set of instructions.

In a third aspect of the invention an apparatus for extracting a key frame from a sequence of frames constituting a shot, each frame being constituted by a matrix of pixels, comprises:

a frame optical flow calculator for computing the optical flow of each frame of said sequence of frames compared to the following frame as a matrix of displacement of each pixel from the frame to the following frame;

a motion entropy measure calculator based on the output of the frame optical flow calculator;

a key frame selector for selecting the frame of the sequence of frames having the maximum motion entropy measure.

Depending on the type of image, a particular embodiment may be preferred as easier to adapt or as giving a better result. Aspects of these particular embodiments may be combined or modified as appropriate or desired, however.

These and other aspects of the invention will be apparent from and elucidated with reference to the embodiment described hereafter where:

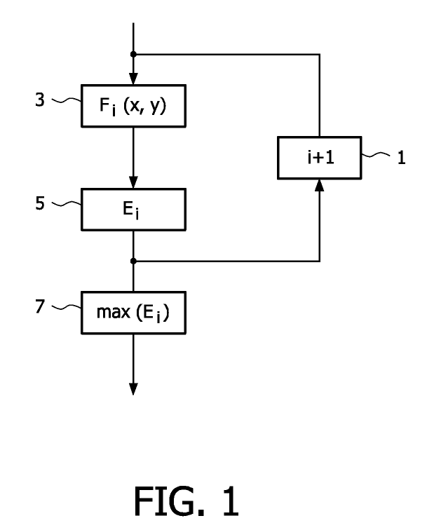

FIG. 1 is a flowchart of a method according to an embodiment of the invention;

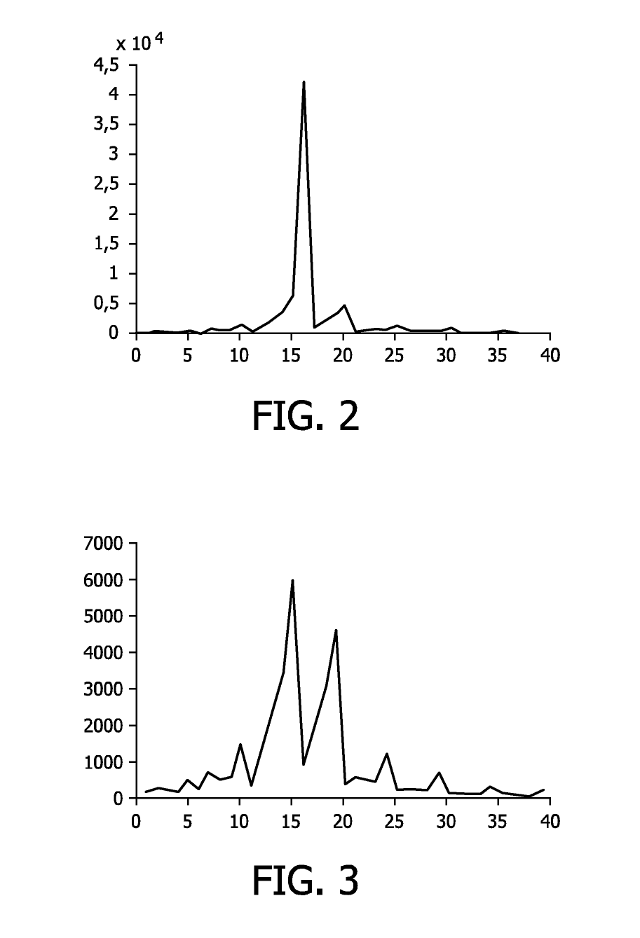

FIG. 2 is a motion histogram of a frame;

FIG. 3 is another motion histogram of the frame of FIG. 2 without the bin having the highest count;

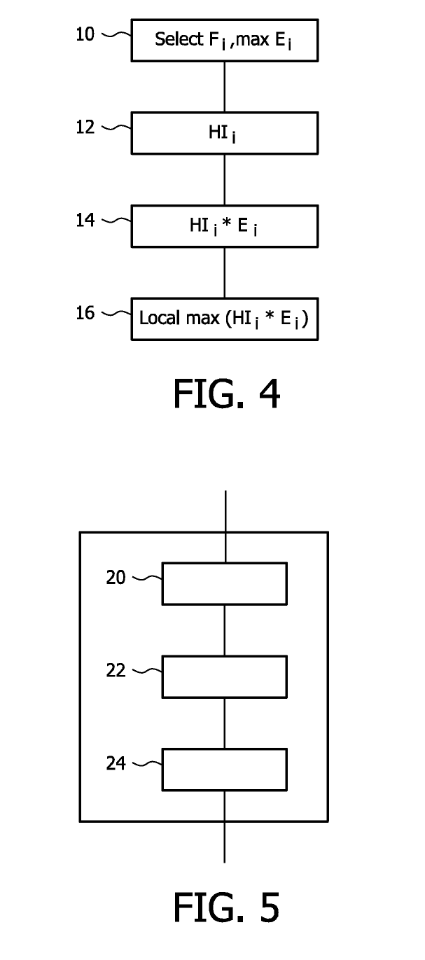

FIG. 4 is a flowchart of a method according to another embodiment of the invention; and

FIG. 5 is a schematic view of an apparatus according to an embodiment of the invention.

In reference to FIG. 1, a method of extracting a key frame from a sequence of frames constituting a shot, each frame being constituted by a matrix of pixels, comprises:
for each frame of said sequence of frames, step 1:
   computing, step 3, the frame optical flow compared to the following frame as a matrix of displacement of each pixel from the frame to the following frame;
   computing, step 5, a motion entropy measure based on the frame optical flow;
selecting, step 7, as key frame the frame of the sequence of frames having the maximum motion entropy measure.

Each step is now discussed in details with specific embodiments.

Considering the computation of optical flow, it should be noted that each human activity gives rise to characteristic motion patterns, which can be easily recognized by an observer. The optical flow is a motion descriptor suitable for recognizing human actions.

In a first step, the displacement of each pixel of the frame is computed by comparison with the following frame as an optical flow field. For instance, the sequence of optical flow fields is computed using standard approaches such as the Lucas-Kanade algorithm.

So, for the frame k, the optical flow Fₖ between frame i and frame i+1 is a matrix of velocity vectors Fᵢ(x, y) having each a modulus Mᵢ(x, y) and an angle Θᵢ(x, y). The velocity vector Fᵢ(x, y) measures the displacement of the pixel (x, y) from the frame i to the frame i+1.

Entropy is a good way of representing the impurity or unpredictability of a set of data since it is dependent on the context in which the measurement is taken.

Based on the optical flow defined here above, a motion entropy measure is computed.

Each velocity vector based on the optical flow output is quantized by its magnitude Mᵢ(x, y) and orientation Θᵢ(x, y). A motion histogram is defined as a predetermined number of bins, each bin being a combination of magnitude and orientation so that the entire spectrum of magnitude and orientation value is covered. For instance, 40 histogram bins which represent 5 magnitude levels and 8 orientation angles are used.

The probability of appearance of the k^{th} bin in a frame is given as:

$${p}_{f} ( k ) = \frac{{h}_{f} ( k )}{M * N} \qquad ( 1 )$$

where M, N is the size of the frame and h denotes the count of the k^{th} bin. P_{f}(k) is thus the ratio of the pixel count contained in bin k on the total number of pixels.

$$E = {\sum }_{k = 1}^{Kmax} {e}_{f} ( k ) = {\sum }_{k = 1}^{Kmax} - {p}_{f} ( k ) * {log}_{2} ( {p}_{f} ( k ) ) \qquad ( 2 )$$

where Kmax is the total bin number in the histogram, in the example Kmax=40, and the sum of all the bin entropies e_{f}(k) is the global entropy of the motion in this frame. the bin entropy measure e_{f}(k) is thus the probability of appearance of the bin weighted by the absolute value of the logarithmic probability of appearance of the bin. As the logarithmic probability is always negative, the absolute value is taken to obtain a positive value as entropy.

Intuitively, a peaked motion histogram contains less motion information thus produces a low entropy value; a flat and distributed histogram includes more motion information and, therefore, yields a high entropy value.

The entropy maximum method disclosed here above provides the information about which frames contain the most complex motions. In some situations frames in which the motion histograms change fast relatively to the surrounding frames also contain important information. Therefore, a second embodiment is disclosed which will be called the inter-frame method, or the histogram intersection method, and which measures the differences between the motions of consecutive frames.

The measure calculates the similarity between two histograms.

The motion histograms of a frame i and its neighborhood frame (x frames leading or lagging) are H_{f}(i) and H_{f}(i±x) respectively, and each contains Kmax bins H_{f}(i, k) and H_{f}(i±x, k) respectively. The intersection HI of two histograms are defined as

$$HI = \frac{{\sum }_{k = 1}^{Kmax} min ( {H}_{f} ( i , k ) , {H}_{f} ( i \pm x , k ) )}{{\sum }_{k = 1}^{Kmax} {H}_{f} ( i , k )} \qquad ( 3 )$$

The denominator normalizes the histogram intersection and makes the value of the histogram intersection between 0 and 1. This value is actually proportional to the number of pixels from the current frames that have corresponding pixels of the same motion vectors in the neighborhood frame. A higher HI value indicates higher similarity between two frames.

In this method, HI is used as the motion entropy measure and key frame is selected as the frame having the highest HI.

This method may be used as a supplemental method for the first disclosed method since it provides extra information about the motion vector distribution between two frames.

In a variant of these two methods, it is noted that a video frame usually has both foreground (objects) and background (camera) motions, and the background motion is usually consistent and dominant in the motion histogram.

As shown in FIG. 2, the highest bin indicates the background motion. The background motion could be eliminated by simply removing the highest bin from the histogram. By doing this, the regions containing the salient objects of a video sequence are focused on. FIG. 3 shows the motion histogram of FIG. 2 after background motion elimination, with only 39 bins left. After background motion elimination, the histogram becomes a better representation of the motion distribution of the foreground objects. The background motion elimination improves the performance of the key frame extraction.

For certain applications such as action recognition, one key frame may not be sufficient and multiple key frames are needed to summarize a shot. Therefore, instead of finding the global maximum of the entropy function for the complete shot, local maxima are searched for. For instance, the local maximum in a sliding window with the length of n frames is considered. Of course, more advanced techniques for finding local maxima can be also employed.

The key frames selected by using the local maxima approach may be used for applications, such as video summarization. For low-activity shots, one single key frame may be sufficient, but most of the time, multiple key frames are needed to represent the contents of the shot. By observing a set of key frames instead of a single key frame, a better understanding of the layout of the shots, e.g. the direction of the movements, changes in the background, etc. may be obtained.

Key frames may be obtained by combining the entropy maxima and the inter-frame algorithms. The combined algorithm extracts frames which not only contain the most complex motions but also have salient motion variations relative to its neighborhoods.
Initial frames are selected, step 10, FIG. 4, by picking local maxima with the entropy maximum method;
Histogram intersection method is applied, step 12, on the selected initial frames;
The entropy values of the selected initial frames are weighted, step 14, by their corresponding histogram intersection values; and
Final key frames are extracted, step 16, by finding peaks in the weighted entropy curve.

The disclosed methods may be implemented by an apparatus, FIG. 5, for extracting a key frame from a sequence of frames constituting a shot, comprising:
a frame optical flow calculator 20 for computing the optical flow of each frame of the shot compared to the following frame as a matrix of displacement of each pixel from the frame to the following frame;
a motion entropy measure calculator 22 based on the output of the frame optical flow calculator;
a key frame selector 24 for selecting the frame of the shot having the maximum motion entropy measure.

The apparatus may comprises input means for receiving shots to be analyzed and output means to send the key frame(s) to a video database index for instance.

While the invention has been illustrated and described in details in the drawings and foregoing description, such illustration and description are to be considered illustrative or exemplary and not restrictive; the invention is not limited to the disclosed embodiment.

The apparatus may be implemented by using a programmable computer and a computer software product stored on a recording media and comprising a set of instructions to enable a computer to practice the disclosed methods when the computer executes the set of instructions. However, due to the highly parallelism of each operations, and the high throughput required specifically by video processing, the man skilled in the art may implement advantageously the system into a specific hardware component such as a FPGA (Field Programmable Gate Arrays) or by using some specific digital signal processor.

Other variations to the disclosed embodiments can be understood and effected by those skilled on the art in practicing the claimed invention, from a study of the drawings, the disclosure and the appended claims. In the claims, the word “comprising” does not exclude other elements and the indefinite article “a” or “an” does not exclude a plurality.

1. A method of extracting a key frame from a sequence of frames constituting a shot, each frame being constituted by a matrix of pixels, said method comprising:
for each frame of said sequence of frames:
computing (3) the optical flow of said frame compared to the following frame as a matrix of displacement of each pixel from said frame to the following frame;
computing (5) a motion entropy measure based on the optical flow of said frame;
selecting (7) as key frame the frame of said sequence of frames having the maximum motion entropy measure.

2. A method according to claim 1, wherein the displacement of each pixel being defined as a vector having a modulus and an angle of displacement, a motion histogram is defined by a predetermined number of bins representing a combination of modulus and angle of displacement.

3. A method according to claim 2, wherein the bin having the highest frequency is discarded.

4. A method according to claim 2, wherein the motion entropy measure is the sum of the motion entropy measure of every bins, the motion entropy measure of one bin being proportional to the frequency of appearance of said bin in the motion histogram.

5. A method according to claim 4, wherein the bin entropy measure is weighted by the absolute value of the logarithmic frequency of appearance of said bin.

6. A method according to claim 2, wherein the motion histogram of each frame is compared to the motion histogram of another frame to define said motion entropy measure of said frame as a similarity measure.

7. A method according to claim 1, wherein a plurality of key frames are extracted by selecting the frames of said sequence of frames having the maximum motion entropy measure in a sliding window with a predetermined length of frames.

8. A method according to claim 7, wherein the displacement of each pixel being defined as a vector having a modulus and an angle of displacement and a motion histogram being defined by a predetermined number of bins representing a combination of modulus and angle of displacement, the motion entropy measure is the sum of the motion entropy measure of every bins, the motion entropy measure of one bin being proportional to the frequency of appearance of said bin in the motion histogram and,
the method further comprises for each selected frames, comparing to the motion histogram of its neighboring frames and weighting the motion entropy measure of each selected frame by the result of the comparison.

9. Computer software product stored on a recording media and comprising a set of instructions to enable a computer to practice the method according to claim 1 when the computer executes said set of instructions.

10. Apparatus for extracting a key frame from a sequence of frames constituting a shot, each frame being constituted by a matrix of pixels, said apparatus comprising:
a frame optical flow calculator (20) for computing the optical flow of each frame of said sequence of frames compared to the following frame as a matrix of displacement of each pixel from said frame to the following frame;
a motion entropy measure calculator (22) based on the output of the frame optical flow calculator;
a key frame selector (24) for selecting the frame of said sequence of frames having the maximum motion entropy measure.
